(19) United States
(12) Patent Application Publication
(10) Pub. No.: US 2014/0059512 A1
(43) Pub. Date: Feb. 27, 2014

(54) Executable Software Building Block

(71) Applicant: David Amos Brown, Indianapolis, IN (US)

(72) Inventor: David Amos Brown, Indianapolis, IN (US)

(21) Appl. No.: 13/594,823

(22) Filed: Aug. 26, 2012

(51) Int. Cl. G06F 9/44

(52) U.S. Cl. CPC G06F 8/00
USPC 717/100

(57) ABSTRACT

A methodology of encapsulating software intelligence in a software application development environment so that software solution construction resembles the independent nature of physical building blocks used to create a physical structural design: Programmatic Intelligence (Program code) that is immediately incorporated and runtime functional when added to a running, finished, software application.

### FIELD OF INVENTION

The present invention relates in general to the means by which software intelligence is recorded in a Computer Programming Environment by persons trained in software technologies as well as those who are not. But perhaps more profoundly, the present invention establishes a new software construct called the “Executable Software Building Block” which transforms the process of creating software intelligence from a complex process of interconnecting functional software objects and tools that have to be further processed to create an executable program to a simple placement of Executable Software Building Blocks in their appropriate locations while the finished program is running to create a software solution. The present invention stands in stark contrast to other present solutions that use similar terminology but are only designed for use by IT professionals or those training in software technologies.

### BACKGROUND OF THE INVENTION

The computer is in essence an intelligence record/playback device. It never does anything that a human didn't specifically inform it how to do. If the computer makes a mistake, it was really the human who wrote the program who made the mistake.

Today, the only way that intelligence is recorded in a computer is through the use of:
A Software Language—a text-based or symbol-based language that must be interpreted before the computer can execute the program
A Software Development System—a program that helps create, edit, and then prepare the program for execution

Both of these items are complex and address subject matter that is not common knowledge to the educated public. In fact, the level of education required to master both of these is equivalent to a bachelor's degree whether formally obtained or self-taught. The reason why it takes so much to be able to sit in front of a computer and make it manipulate all kinds of information at will is because there is so much that must be known about the computer: how it works, how Information is handled by it, the standards in the industry for data communications, knowledge of the operating systems that your intelligence will be playing back on, and the list goes on and on. Creating software intelligence through the use of the mechanisms above is so far out of the reach of the general public as to render it “impossible”, as so many knowledgeable persons have asserted.

Value-Centric Programming is a new methodology for creating, editing, and executing a software program as detailed in PTO Publication 20120180033. Value-Centricity and the use of Executable Software Building Blocks allows intelligence to be added to a program in a nearly identical manner as physical building blocks, which reduces the complexity of creating software intelligence to something similar to the all too familiar children's favorite building-block toys that can't be mentioned by name. Executable Software Building Blocks are Functional Building Blocks and Data Building Blocks that are applied as needed to a Computer User Interface as part of a larger solution that has a specific Information Task to perform.

### BRIEF SUMMARY OF THE INVENTION

A lot has been done over the years to make programming easier for professional-level programmers to construct and manage large complex programs for Operating Systems like Windows. Perhaps the most significant of these advancements is the concept of Object Orientation where custom Classes and Objects became a common organizational method for consolidating software intelligence into meaningful entities that have defined behaviors and data. This makes it much easier for the programmer to conceptually think about behavioral aspects of a complex system, which helps enormously with the process of writing the software that manages those behavioral software objects. The concept of Software (intelligence) Encapsulation enabled great advancements in Information Technology because it helped the programmer to think more clearly about the “bigger picture” or rather the purpose of the program as it relates to the User and/or the Data that is being managed.

But there exists one more and last level of Encapsulation that was not possible with subroutine-based software. All software today with the exception of Assembly Language Software is architected as a Functional Software System made up of an interconnected set of Functional Software Objects and Tools. There always exists one highest level of software intelligence that must manage the Functionality of the whole system. It is this highest level of intelligence that is the most difficult to create because it has so many decisions to make and information to consider to continue to operate flawlessly in all situations with inexperienced users sometimes at the helm. Enter the typical buggy program.

The highest level of Encapsulation sets Data free to take care of itself. It allows the relegation of all responsibility over the equivalency of all Data in the system to the software intelligence that is managing each Value or List (treated like a Value) in the accessible Data Environment that a program runs in. This highest possible level of Software Encapsulation ushers in a new age of Intelligent Data Systems constructed of Executable Software Building Blocks whereby Intelligent Data determines programmatic behavior.

### BRIEF DESCRIPTION OF THE DRAWINGS

Below is a brief description of the attached drawings that will used to describe the present invention.

FIG. 1 shows the Software Building Block construction of a Table Software Building Block and is exemplary of the additive nature of Software Building Blocks.

FIG. 2 shows a Table Software Building Block as it appears on a User Interface.

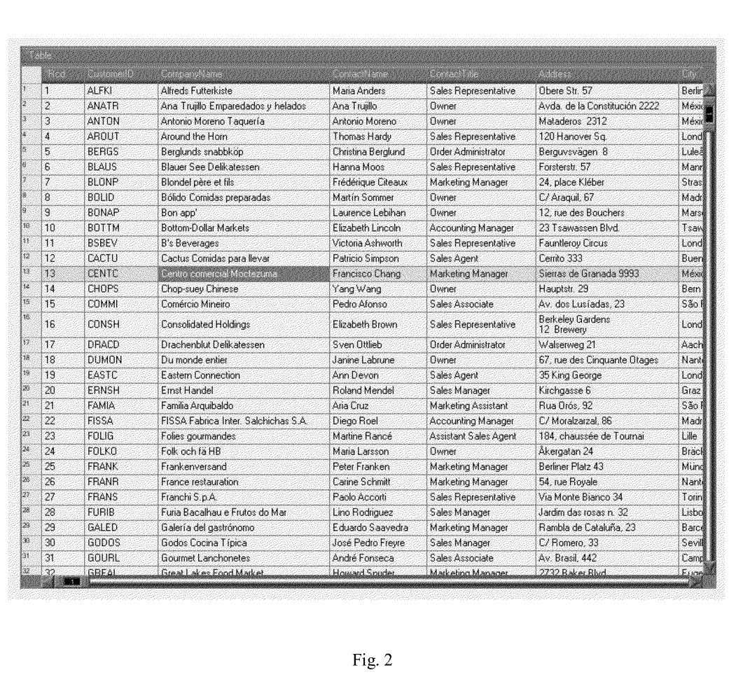

### DETAILED DESCRIPTION OF THE INVENTION

As stated, all software to date except Assembly Language Programs are architected as a set of subroutines. Some programs have a main routine that runs continuously monitoring system operation like Windows, while other programs have an entry routine that starts the program. Every subroutine is one or more lines of program code and has a specific functional purpose. Subroutines are an arbitrary construct which means there are no rules concerning what is done in any subroutine so lines of code in a program can be reorganized and regrouped into any number of possible combinations of subroutines. Subroutines are mere constructs that helps the programmer think more clearly about his/her code by dividing it up into smaller more manageable functional pieces. In some sense you could call a subroutine a Building Block. It is a functional self-contained thing but subroutines are designed as a tool for the rest of the program to use which means they are not independent—they are just blocks of code to be run on demand by something else in the system.

Grouping lines of program code to create a more manageable software entity that interacts with a software system is called Encapsulation. Encapsulation can be utilized at any level of a given program's software architecture. Encapsulation creates Software Objects that are a combination of Subroutines, Data, and Events. The purpose of Encapsulation is to create a more manageable construct of program code. The key word here is “manageable” meaning something in the system is always in control of that encapsulated “thing”. A Software Object can make Public (external software has access) any of its Subroutines, Data, or Events for use in system interaction. A Software Object is only useful if an external entity can call its Subroutines, read its Data, or subscribe to its Events. A Software Object is not an independent software entity.

The purpose of Encapsulation is to consolidate as much of the program code as possible into meaningful software entities that can be combined to create a larger Software Solution. To put it another way, the intent of Encapsulation is to increase system independence of the functional software entities in the system so that it is easier to create the system.

What makes Intelligent Data Encapsulation possible is a new Law concerning Software Technology:

The Law of Value-Centricity

The Intelligence of a Computer Program, which is contained in the Program Instructions of its subroutines and main routine and is used to manage Information that it requires to perform its intended Function, can be distributed among the individual Data Values in the managed Information transforming them into Autonomous, Intelligent Values whereby the Execution of the Program changes from a call sequence of subroutines that manage the Data to a sequence of Intelligent-Value Updates that constitute the managed Data and are sequenced by the programmer in an intuitive, as-needed manner to accomplish the same informational end. Thus, a Managed-Intelligence Computer Program is transformed into Independent, Intelligent Data that reacts to the changing Data in its environment. Program execution in a living model.

The Executable Software Building Block is the realization of the Law of Value-Centricity.

Laws are provable. So let's prove it for all programs in 2 simple strategic moves.

Transformation of a Function-Centric Program to a Value-Centric Program

The subroutine is the foundational software construct of most of the programs that have ever been written. All but Assembly Language Programs get their work done through the use of subroutines. But even Assembly Language can make use of the concept of subroutines to make coding easier and more organized. A subroutine is nothing more than a Functional grouping of program code lines with an interface that facilitates its use by other subroutines. Every program can be written an infinite number of ways with an infinite number of variations of the subroutines constructed, named, and used. With the exception of some programming languages that let the programmer declare a new variable and initialize it all in one line of code, everything programmatic that occurs happens within one of the program's subroutines. Therefore, if one subroutine can be validly converted to a set of Intelligent Values and that subroutine is representative of all subroutines, then all of the subroutines in the Computer Program can be converted to Intelligent Values.

The subroutine structure, which is common in all Programming Languages except Assembly, is a very simple construct. Every subroutine contains a means of providing it information to work on, and some have a formal method of returning one variable. Almost all languages allow for some of the provided information to return altered after the subroutine has finished executing. All subroutines can call other subroutines in the process of executing. The variables declared and used within a subroutine to accomplish its task are destroyed after the subroutine finishes executing. This is known to someone knowledgable in the art as a Variable's “Scope”. If a Variable is declared within a subroutine, its Scope is “local”. If a Variable is declared within the Main subroutine (highest level running the program) then it is outside of all the other subroutines and is commonly referred to as having a “global” Scope, which means that all the other subroutines have read/write access to those Variables.

From a system point of view, there are only 4 things that can occur within any subroutine:
Variables are declared within the subroutine to be used as interim Values and evaluated through calls to other subroutines
Variables outside of the subroutine are evaluated through calls to other subroutines
The Return Variable is evaluated through calls to other subroutines using interim Values
Testing, Branching, and Looping are used to control the above processes

One of the Variables declared locally will be the formal return value (as opposed to inputs returning altered) for subroutines that return a value. Subroutines that return a value are used primarily to provide information to the calling subroutine and are known as “Functions”. Subroutines that do not return a value are known as “Subs” and are used to do work outside of the calling subroutine.

It is clear that the primary function of a subroutine is to evaluate Values, whether locally or externally to itself. If the subroutine is calling other subroutines that don't return a Value then it probably needs to set Values externally that relate to its purpose and needs those subroutines to accomplish that end.

It is important to digress for a moment about evaluating values anywhere in any Program:
During Program Execution, there only exists a memory map of Data (information that persists) that is changing over time within the computer. The Registers, Stack, Heap, and Program Code that constitute a running Program's functional architecture are all just locations that are addressable by the Operating System. All a computer is ever doing is changing individual values within that memory map. Every single time an Opcode is executed in the Processor, the only evidence of that operation is one or more values change in the memory map. The Computer is an Information Tool ONLY. If it changes no information, it does no work.

Value-Centric Conversion Step 1: Make All Variables in the Program Global

Every programmer can tell you that the scope of any Variable is a personal choice. Any Variable declared in a program can be moved to a Global Scope and still be used by the existing software unmodified. By moving the declaration statements for every Variable in the program code to the entry level of the program (Global Scope), those Variables are available to read/write by any software code in the system. They are read and written to by Name. All the declared Variables in contemporary programs are stored and managed on the Heap together anyway. Their declared Scope is a logistical tool used to protect Data Integrity. If the programmer never made a mistake, Data would not need to be protected through Variable Scope Management.

Value-Centric Conversion Step 2: Consolidate All the Lines of Code that are Used to Evaluate Each Individual Global Variable Into a Single Name-Accessible Software Construct for Each Global Variable in Step 1

Here's where the arbitrary nature of subroutine construction plays an important role. From the entry level of any program, I can write new code that does the exact same information modifications as my original set of subroutines. There is no Software Object I can't make a new instantiation of to set Values whereever they need to be set. There is no Software Tool that I can't take the code lines and incorporate them into new code that does the same thing in a different subroutine.

There is an implied Step within Step 2: Consolidating lines of program code that were all being used to evaluate the same Variable in different places of the program means removing redundancy if it exists and cleaning up the Logic that determines the State of the System and the resulting evaluation that will be conducted. The fundamental difference in the modified program will be that all the code everywhere in the program has one singular purpose—evaluating one Value accurately given the State of the System. This is called Functional Clarity and is presented as a strict requirement for the error-free application of logical intelligence.

Now we can see Value-Centricity clearly. Value-Centricity is all about assigning responsibility of Data Accuracy to where it should belong: where the focus is one Value and only that Value. The Intelligence to evaluate Data should reside where the Data exists and be the only entity that has the knowledge and capability to change that Value (Data Integrity). It's like assigning one person to guard and keep current one Value and that is the only responsibility that person has and no one can usurp that authority. You teach this person how to evaluate their Value in all conditions (Program State). Once they have been trained (Programmed), they sit and wait for conditions to exist (State) during Program Execution that cause them to change. From that point on, the only thing that person needs to know is the State of the system at any moment in time. They never take any new orders or respond to any external commands. They have complete and absolute Autonomy over the Value they are assigned to. And they gladly provide their Value to anyone in the system who needs it. Free and Independent entities that have defined behavior, fulfill their needs FROM their environment, and respond to changes IN their environment—this is a Living Model.

Doesn't it make sense that a Living thing (where it all began) that uses Information to apply its Intelligence do so using a Living Model of that Information? Is the Human Mind Value-Centric?

It may sound peculiar personifying software but really it IS the recorded Intelligence of a human. Therefore, it is extremely helpful to view a software system in terms of a team of humans working on a problem together with clear roles and responsibilities (hopefully). Fortunately, they know NOTHING of anything outside of their purpose nor are they concerned with it.

Back to our Subroutine Conversion

Here's what happened to our original subroutine:
Variables are declared within the subroutine to be used as interim Values and evaluated through calls to other subroutines
   we moved the declarations to a Global Scope and continued to use them by Name in our modified subroutine
Variables outside of the subroutine are evaluated through calls to other subroutines
   we moved these lines because they evaluated Variables that were or became Global Variables that can be evaluated where they are
The Return Variable is evaluated through calls to other subroutines using interim Values
   We do this in our new Named construct for our original subroutine's Return Variable. The code in the new Named construct still uses the original interim Variables in their new constructs by their original Variable Name
Testing, Branching and Looping are used to accomplish the above
   These code lines are used as a tool to control the evaluation of Variables. They are cleaned up in the new construct to accomplish the same end

We do this process to every subroutine in the Software System and what we are left with is nothing but Global Read-Only Properties that contain reordered program code and are read from by Name.

SomeVariable=MyNamedReadOnlyProperty

This is how Properties (code) are used: SomeValue=PropertyName which just runs the code within the subroutine being used which is called a Property. It's not really a Value. It's the result of calling code. We just call them Properties and use them as if they were values. That's what Value-Centric Intelligent Values look like. An Intelligent Value can be viewed as a subroutine running code to evaluate one Named Value that persists after the subroutine completes.

To achieve any result from the modified Program, the Programmer simply creates a sequence of Intelligent Read-Only Properties (Values) in the system the last of which is the answer desired. We get the Return Value of the original subroutine by calling it by Name. We just didn't have to provide it any Input Information because that Input Information became Global and the code in our modified subroutine can go read it itself.

Where does the sequence come from?

All these Global Values that we created from our original program are continually informed of any other Global Values that change in a Value-Centric System. The sequence occurs by recording in each Global Variable's code (through Value assignment) which Global Values it follows whenever it updates its evaluation. If it is informed of one of these “Trigger” Variables, it will update.

There is Only One Event in Value-Centricy:

### A Value Changed (The Aggregate State of the Environment Changed)

The Bigger Picture

Now we have an environment of changing Intelligent Data. What can we do with it? How does that help us DO things in the computer?

If you're stuck on the concept that the Computer DOES things which it doesn't except change Data, let's go back to looking at the Computer in terms of the functional capabilities we can create with Programming and how those capabilities are really Value driven. In fact, every Process in the Universe is Value driven. I cannot do a single thing without the knowledge of how to do it and when to do it. Both of these are Information. Data precedes Action because Action needs Data but Data cannot exist without the Action that created it in the first place. Before there was anything, there was knowledge that it was possible.

Functional Capability can be viewed through the Values that drive it. We see it all the time. If I want a dot on the screen to change color (a capability which can be viewed as a behavior), I change the value in the system that holds the current color of the dot. It's only the perspective you choose. The Data gets changed and a behavior is obtained. Was something DONE or DATA CHANGED? The answer—both—what was DONE was that DATA was CHANGED and you perceived a resulting Behavior in the changing-color dot.

This is how Computer Functionality can be designed through a construct of supporting Values. For example, If I want the capability to play sounds in the Computer, I could write the code that knows how to get at those Functions in the Operating System and control it using a few Values that the User can understand. In this case, all that is needed from the User is the path to the file that contains the sound that is desired. The User views this new thing as a capability of the Program and if it is automated, then it becomes a Behavior: the sound plays when certain things occur in the Program because that file path changed or a “Run” value changed or some other Value changed.

Here is where lay and professional programmers diverge. The Professional Programmer has the skill to make the computer do anything he/she wants given a subroutine to do it. If the Professional Programmer writes code that a lay person can't and provides a simple interface to that code that the lay person CAN understand then ALL of the functionality of the Computer could be wrapped with simple Values and provided to the lay programmer to use if the Functional purpose of this software “Thing” is understood. For example, a Professional Programmer could write code that shoves Text out the USB port. The lay person doesn't need to know anything except the Text he/she wants shoved out the port which they ARE capable of.

We'll leave this section making one important point. All the variables that get declared within a Program regardless of where they get declared or what their Scope is, require Program Code that evaluates their equivalency no matter where in the Program they are evaluated. The fact that Programming Variables means the code is more scattered than in the subroutine model of a Program means nothing negative about the Quality of the Program. You still:
Need every Variable to complete the Program Solution
Have to write code that keeps every Variable accurate and up-to-date

The biggest difference between writing Function-Centric software and building Value-Centric Solutions is that in Value-Centricity, Functional Clarity reaches its highest attainable level. There is no ambiguity or confusion about what occurs in a Value-Centric Program. Every execution Thread is just a sequence of Value updates.

Value-Centricity does not change the nature of Program Code per se or even add to its length. It just rearranges it to fit a living model that makes more sense to everyone and yields a host of runtime benefits. Value-Centricity allows any Function in the Computer to be wrapped with Values that a lay person can understand and manipulate so that the novice Programmer can still use that Function in a larger Program Solution by just adding it. If we have to jump around more to build a full Program in Value-Centric—so what—as if programmers don't have to jump around a lot in subroutine-based programs. If the Program runs more reliably and is clearer to the mind of the Programmer (and therefore requires less troubleshooting) then we've marched Forward in the technology. I, for one hate the nested structure of today's Programs. It's hard to know where the code is running at any given moment to figure out why it is making errors.

The Executable Software Building Block

Programming is hard because today's software internal runtime structure is so intertwined and inter-dependent. The Functionality MUST be made independent so that it can be added anywhere in the Program and still fulfill its purpose. In Function-Centric Programs, new Functionality means either a new Class or a new Class subroutine or a new System subroutine and all the other subroutines that might call it have to play nice or the system crashes or worse—it puts out bad Data that you don't notice immediately. Value-Centricity eliminates Functional inter-dependency by wrapping every Functional software “thing” with independent changing Values that drive its behavior.

Enter the Software Building Block which is an Independent Software Entity that combines Functionality with Intelligent Data to produce an architectural structure that simply needs to be placed anywhere in the Runtime Environment where it can communicate with the Data Environment to retrieve Information it needs to fulfill its purpose. Actually, the software intelligence that coordinates the activity of an Executable Software Building Block does nothing to retrieve Data itself (except the Table) but rather the individual Values in its architecture know where and when to go get Data and the ESBB software intelligence reacts to those changes. Even the software boss of an Executable Software Building Block is not in full control in Value-Centricity. The individual Intelligent Values make the ESBB intelligent by providing it with intelligent Data to work with. Its all about independence while still fulfilling the roles that must be played and the responsibilities that must be met by software intelligence to complete a complex informational task. It's also about learning the benefits of shoving responsibility and intelligence down to the lowest levels possible within a complex system to achieve better performance. In software as in organizations, the model has been to have a central intelligence and authority which enacts its will on the system. Client/Server systems follow this model. They work great but is there a better way? Do you want smarter Generals or smarter soldiers with more responsibility?

The Executable Software Building Block System starts with a minimal set of Blocks needed to fulfill the needs of the majority of Programs. This set consists of:
1. Value Data Block—any Data Type—can be converted to Intelligent Value (Programable)
   a. Text
   b. Numbers
   c. Dates/Times
   d. Logic/2-State
   e. Picture
   f. Audio
   g. Video
   h. File
   i. Anything Converted to Text Description (Text)
2. Value Control Block—any Data Type—comprehensive Settings can be converted to Intelligent Settings Values—Programmable
3. List Data Block—any Data Type—can be converted to Intelligent List—Programmable
4. List Control Block—any Data Type—comprehensive Settings—Programable
5. Table Data Block—any Data Type—some Settings for Table Management (Programmable Selections by Column, etc)
6. Table Control Block—any Data Type—comprehensive Settings—Programmable
7. Assembly Data Block—any Data Block or Control—no Settings Values—Programmable
8. Assembly Control Block—any Data Block or Control—comprehensive Programmable Settings
9. Picture Data Block—Picture Data—no Settings Values
10. Picture Control Block—Picture Data—comprehensive Settings—Programmable
11. Audio Data Block—Audio Data—no Settings Values
12. Audio Control Block—Audio Data—comprehensive Settings—Programmable
13. Video Data Block—Video Data—no Settings Values
14. Video Control Block—Video Data—comprehensive Settings—Programmable
15. Counting Loop Block—Programmable Settings for Operation
16. Conditional Loop Block—Programmable Settings for Operation
17. Addressable Value Function Block—Common Data—retrieves Values
18. Addressable List Function Block—Common Data—retrieves Lists
19. Addressable Assembly Function Block—any Data Type—retrieves Assemblies
20. Text Function Blocks—core set of Text Manipulating Functions—AddText, FindText, LeftText, RightText, MiddleText, ReplaceText
21. Number Function Blocks—core set of Math Functions
22. Date Function Blocks—core set of Date Functions
23. Time Function Blocks—core set of Time Functions
24. Logic Function Blocks—AND, OR, NOT, XOR
25. Conditional Branch Function Block—Common Data single value test—Assembly Data Result (can be anything in the Result)
26. Task Function Block—ability to execute a Task when executing an Intelligent Value Expression
27. Task Control Block—ability to put Sub-Tasks in Tasks
   a. Dialog Task—a Program that interacts with the User and must be completed
   b. Auto Task—a Program that opens itself hidden and executes when a condition is met (State of the System)—can be viewed
   c. User Task—a Program that opens itself ready for User Interaction
   d. Process Task—a Program that is a part of a larger Program
   e. Service Task—a Program for protected interaction between two Tasks (can be in another Value-Centric System)

In order to create a fully functional Programming Environment, you need a minimum of capabilities:
1. The ability to add Data and Functional Controls to a Custom Interface
   This is the only way to add Data or Function in a Value-Centric environment
2. The ability to create Data of any Form and Type or combinations of Forms and Types
   The 4 Forms and 8 Data Types cover all Information except multi-dimensional arrays
3. The ability to retrieve Common Data for processing by Function
   Addressable Values, Lists, Assemblies retrieve Text, Numbers, Dates/Times, Logic
4. The ability to manipulate Common Data through their associated core Functions
   Core Functions for the 4 Common Data Types—Text, Numbers, Dates/Times, Logic
5. The ability to Test values
   Logic Tests on Text, Number, Date/Time, Logic
6. The ability to Conditionally Branch program execution
   Conditional Branch Function provides this in Expressions
7. The ability to Repeat controllably
   Multiple methods of looping—in Tasks (active environment) only
8. The ability to compile the Program
   The concept of “Compile” does not apply to Value-Centricy—when anything is added, it is immediately part of an active, finished Program
9. The ability to Run the Program
   The concept of “Run” does not apply to Value-Centricy—there is no Run State—Values are independent—they update in response to other updates if Intelligent
10. The ability to Save the Program
   Of course

Everything in a Value-Centric Program is an Executable Software Building Block of one kind or another. They are Hierarchical structures that are added as needed to the Hierarchical structure of the Runtime Environment (the existing construction of Software Building Blocks) where it makes the most sense to the Programmer. The Hierarchy starts with the Central Computer in the System. The entire Hierarchical system can be described as:

A Central Computer with other Computers, Databases, Processes, Services and Workspaces
Computers with Databases, Processes, Services and Workspaces
Processes with Tasks, Data Controls and Functional Controls
Services with Tasks, Data Controls and Functional Controls
Workspaces with Tasks, Data Controls, and Functional Controls
   Tasks with Tasks, Data Controls and Functional Controls
   Controls with Settings (Values or Lists)
   Settings (Value or List) with Expressions if made Intelligent
   Expressions with Function Controls, Data Controls and Tasks
      Function Controls with Addressable Values or Lists
   Data Controls with Values, Lists, Assemblies
      Tasks with . . .
Inside a Task the Hierarchy repeats
Inside an Assembly the Hierarchy depends on what is in the Assembly

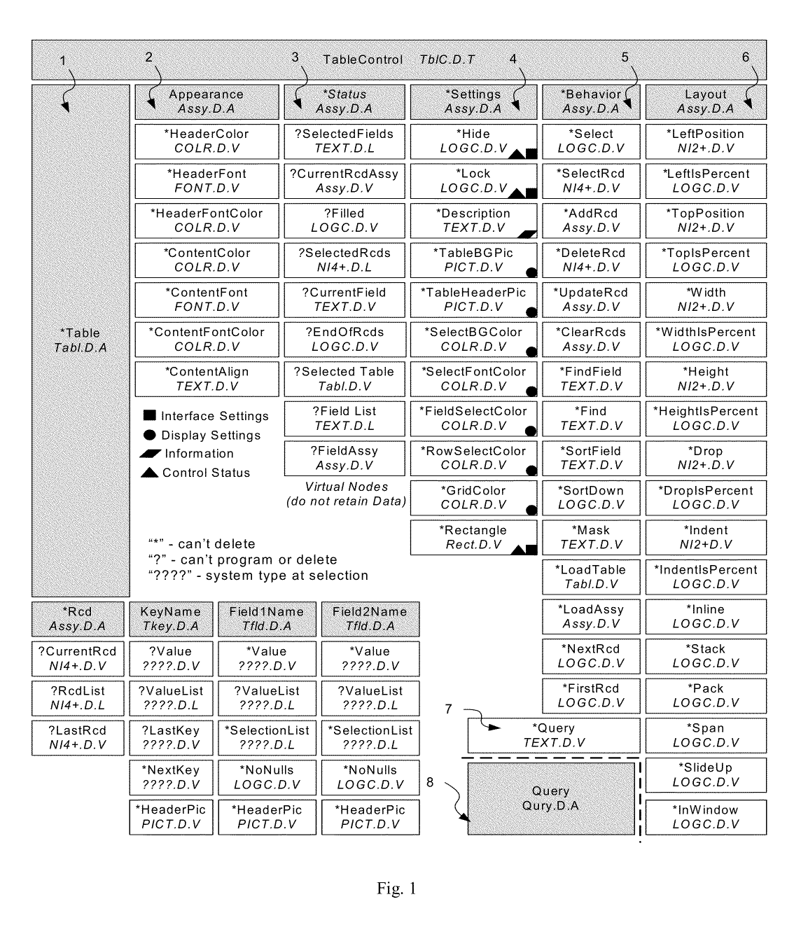

The best way to describe how an Executable Software Building Block looks and works in a Value-Centric System is to discuss a specific ESBB that is needed in most programs. The all-important Table in seen in FIG. 1. The Table ESBB uses other Executable Software Building Blocks in its design and is perhaps the most complex ESBB in the System. This is because the Table is where all the Forms and Types of Data come together and is the primary mechanism for storage and retrieval of Data for processing. Tables have a host of functional operations needed to support the Program and the User:
Style (decorative appearance)
Search (manual and SQL)
Sort
Scroll
Select
Set
Save

Because Programming is the the process of recording Human Intelligence, the design of Executable Software Building Blocks tries to give the Program the same capabilities that the User has.

In FIG. 1, the greyed Nodes are Assembly Software Building Blocks that have other Executable Software Building Blocks in them. The hierarchy is shown vertically because of space. All the ESBB's have Name and Type designators. The way to read the Type designation is a follows:
1. 4 character unique Executable Software Building Block designator
2. 1 character Data verses Address designator (D or A)
3. 1 character Data Form designator (V for Value, L for List, T for Table, A for Assembly, C for Collection (Assembly of one Executable Software Building Block Type)

Every Executable Software Building Block has a unique Address to it inside the Table Software Building Block structure as well as the whole Runtime Structure.

As can be seen in FIG. 1, the Table Software ESBB contains 6 Assembly Blocks. [TableControl] [*Table] 1 is a raw Data Table (no programmable functionality) that can stand alone if only Data is wanted and the Programmer wants to keep the Runtime Environment down in size. The rest of the TableControl Building Block 2,3,4,5,6 are Settings Values that can be made into Intelligent Values or User modified. The Names of the Blocks in FIG. 1 alude to their purpose and therefore, most are self explanatory: For example, HeaderColor is the color of the Name Header of an Executable Software Building Block on a User Interface (and sometimes other parts for styling). The common categories of Settings for all Executable Software Building Blocks are:
Content (the Data)
Appearance (fixed set for all Software Building Blocks—optional)
Layout (fixed set for all Software Building Blocks—optional)
Behavior (specific to a Block)
Status (some standardized, some Block specific)
Settings (catch-all for Settings that don't fall into the above categories)

Add the word “Intelligent” before the categories and you get the effective result when Settings are made into Intelligent Values: Intelligent Appearance, Layout, Behavior, Status, and Settings. Settings that become intelligently applicable given the State (instantaneous set of all Values) of the System. Layout and Appearance are optional because of their size. If the Programmer needs to programmatically modify the User Interface Layout of a Building Block, he/she needs to add the Layout Settings Assembly Building Block to that Executable Software Building Block. The same is true for the standard Appearance Settings.

The category of Settings for an Executable Software Building Block that we are most interested in here is the Behavior Settings because these Settings give the Table Executable Software Building Block the same capabilities as the User to manage the Table Data. Let's examine these more closely.
Select
   All Executable Software Building Blocks can receive System Focus (User interaction focus). When this Value updates, the Executable Software Building Block becomes the Focused Control on a User Interface.
SelectRcd
   A numbered Value that when updated causes the Table Executable Software Building Block to select a Cell in the currently active Column (where the Current Cell is) on the record that has that value in the “*Rcd” Column.
AddRcd
   Adds a blank record to the end of the Table. NoNull Columns are filled either by a default value for the Data Type (usually 0) or by interacting with the User for an initial value like for Key Column names or numbers.
DeleteRcd
   A number value that causes the record specified in the “*Rcd” Column that matches to be deleted.
UpdateRcd
   An Assembly of Data Values. The Table Executable Software Building Block will update the Current Cell Record with Data from the Assembly that matches Name and Type in the Table. Non-matching Data is ignored.
ClearRcds
   Deletes all records.
FindField
   Text Value. Sets the current search Column
Find
   Text Value. Text to find in the active Search Column. The Table ESBB will move the Current Cell to a found value and center the new Current Cell in the view.
SortField
   Text Value. Sets the current Sort Column
SortDown
   Logic Value. True=Ascending
Mask
   All of the display elements of all Software Building Blocks are maskable like Headers, Borders, Grids etc. When all the elements are masked only Data shows. This helps with creating programmable documents and other visual effects. The Mask is a string of 1's and 0's entered by the User or Program. Each character in a Mask string identifies a specific element to make visible or hidden. A “1” masks out a display element and makes it invisible.
LoadTable
   Assembly Value. Tables as with all Software Building Blocks can be collapsed to a Text Description. LoadTable loads a new Table from a Text Description (Value) of a Table Assembly.
LoadAssy
   Assembly Value. Adds a new record from a Text Description (Value) of an Assembly. Only matching Names/Types are used.
FirstRcd
   Logic Value. Causes the first record in the current record order to be the Current Cell Record.
NextRcd
   Logic Value. Causes the Current Cell Record to move to the next record in the current record order.
Query
   SQL Text Value. Causes the Table ESBB to send out a Query to get new Data. A Value-Centric Query is exactly like an Expression in how it works. It is a special Expression that programmatically builds an SQL statement thus providing for programmable Queries.

Dropping Controls on a User Interface to create a Program is obviously not new. Let's look at the differences between a Table Control in Microsoft Visual Studio which is used to create Programs and the Table Executable Software Building Block.
Visual Studio Table Control
A Table Control in Visual Studio has a myriad of Properties (Settings), Methods, and Events for managing a Data Table. Events are automatic (way to tell the System about changes) after creation but the Properties have to be set by external entities during runtime. All the Methods have to be called by external programmatic entities or effectively called by an external entity (one initial inside Method calls another inside Method).
Table Software Building Block
A Table Executable Software Building Block is a truly independent software entity. The only programmatic interaction with a Table ESBB is as follows:
   The System continually informs the Table ESBB of every Data change in the Runtime Environment
   The Table ESBB retrieves Data for its Contents by SQL
   The Table ESBB processes SQL and Address-based requests for its Data
   The User Interface Layout Manager tells the Table ESBB its location and size on the User Interface (if not in FreeForm). The Table ESBB complies by moving and sizing accordingly.
The Table Executable Software Building Block only needs to know about the other ESBB's that are changing around it and have access to the Data it needs to fulfill its purpose. The Table's programmatic intelligence does all the rest.

All Executable Software Building Blocks maintain the same level of independence from their Operating System: System Status (data changes) and Data Access (addressable data) are all they need to fulfill their purpose. That independence is relagated when an Executable Software Building Block is used to construct another ESBB. The owning Executable Software Building Block becomes the Jurisdictional Authority over all the Data in its Jurisdiction (that Executable Software Building Block's Assembly). In other words, the Programmatic Intelligence of an Executable Software Building Block has read/write authority over all Data in its Assembly. Nothing else in the Operating System can usurp the authority of an Executable Software Building Block. The Operating System puts command-oriented firewalls around every ESBB (specific messages do not pass through) to enforce this authority.

System Membership and Independence

Any part of a system has to communicate with the system or it cannot be a Functional entity IN the system. Any part of a system has to have some information about the system or it cannot function as a part of the system. Every part of a system has to be able to access some level of resources from the overall system otherwise the results generated by that entity are not related to the operation of the system.

Value-Centricity and Executable Software Buiding Blocks take Encapsulation to the last and highest level of functional independence possible for any software entity in a Program. That level of Encapsulation limits interaction to:
Information from the System that is relevant to operation
Access to Information in the System needed for operation
Status Information to the System relevant to operation

This represents a minimum of Program interaction between a system and the entities in the system. Executable Software Building Blocks have no Methods that are callable nor Properties that are managed externally. The only Events are when an Executable Software Building Block informs the System of any Data changes. There exists no level of command and control between an Executable Software Building Block and the Operating System outside of positioning and sizing on a User Interface. An Executable Software Building Block and its Operating System “cooperate” to complete an overall Informational Task. The System provides Information to the ESBB and the ESBB provides Information to the System.

Once this level of Software Independence is achieved, software construction can take on the feel of physical building blocks and how they combine to complete a larger structural design. In a Value-Centric Program, that structural design is Informationally Functional.

Building Blocks Clarified

A lot of professionals in the software industry use the term “Building Block” very loosely (PTO Pre-Grant Publication 20090037875). All things that can be combined to create other things could be called Building Blocks. A Transimission can be called a Building Block of an automobile. Every subroutine can be called a Building Block but something has to combine those subroutines into a meaningful and effective software solution.

A true Building Block in the strictest terms is simply a 3 dimensional object that is physically placed as a part of a larger 3 dimensional physical construction. Once a block is placed or removed, the operation is completed and the construction has a new State. There is no other operational mode other than Construction. Once a block is placed, it has fulfilled its purpose.

The Use of True Building Blocks Involves a Single Operational Mode—Construction

In Value-Centricity, Construction and Operation are the same mode.

All existing software solutions that combine what they call “Building Blocks” into a larger solution require an intelligent process outside of the software solution to complete an executable application. They all have distinct Design and Execute operational modes.

There is no final-product subroutine-based software solution that exists that can modify its fundamental functionality while it is in its Final Application Runtime Mode. Instantiating and Linking Dynamic Link Libraries (how it is done currently) while a program is running changes the functionality of the program but that functionality was planned for in the creation of the software application and represents Software Intelligence that already exists and has been pre-processed by a software development program to prepare for its dynamic inclusion. Executable Software Building Blocks have no such limitation. Brand new, never created Logic and Software Intelligence can be created and used without ever stopping the program.

The present invention can be applied to subroutine-based software programs by providing the Information flow required by Executable Software Building Blocks that has been discussed. In other words, the present invention and its concepts can be simulated within a contemporary subroutine-based runtime environment to take advantage of the level of Software Independence that only Executable Software Building Blocks can attain in a Value-Centric or simulated Value-Centric Environment.

Executable Software Building Blocks in a Value-Centric or simulated Value-Centric Programming Environment allows software design and construction to be simple enough to include lay persons as creators of Programmatic Intelligence as well as providing a platform for professionals to create many Data-Management programs in a fraction of the time that contemporary programs take to create because the Value-Centric Operating System handles all the computer constructs and Variables that are required to work directly with the Computer Operating System. The Programmer works directly with the Data of the Application and any other Data needed to process the Application's Data.

Value-Centricity and Executable Software Building Blocks let the Lay and Professional Programmer work on the Solution and forget about the computer or compiling code or even code itself.

What is claimed:

1) a means of modifying the software intelligence (effective program code), and therefore the fundamental functionality, of an actively-running finished-product software program through the addition or deletion of selectable software assemblies henceforth called “executable software building blocks” whereby the aggregate functionality and software intelligence of said finished-product software program is contained solely within the aggregate combination of said executable software building blocks that were added or removed during the runtime execution of said finished-product software program.

2) The means of modification in claim 1 encompassing the capability to create new Logic and Software Intelligence (effective program code) that did not exist in any form previously whereby said new Logic and Software Intelligence, when added to the finished-product software program in claim 1, is immediately incorporated and available for system runtime access and use without interruption to the operational mode of said actively-running finished-product software program of claim 1.

3) The actively-running state of said finished-product software program in claim 1 being characterized by the continual fulfillment of the informational purpose for which said software program was created without interruption or identifiable change to said program's operational mode.

4) The finished-product software program of claim 1 being characterized by a machine-storable representation (instantaneous version) of the Software Intelligence of said software program of claim 1 that will be executed in all future applications of said software program without the need for the characteristic processing by a software intelligence external to said Executable Software Building Blocks of claim 1 that is required by contemporary software programs to operate as a unified functional software system when software modifications are implemented.
